(19) United States
(12) Patent Application Publication
(10) Pub. No.: US 2026/0299341 A1
(43) Pub. Date: Oct. 1, 2026

(54) DISPLAY PANEL AND DISPLAY DEVICE

(71) Applicant: HKC CORPORATION LIMITED, Shenzhen (CN)

(72) Inventors: Zhouchen PU, Shenzhen (CN); Guangping WEI, Shenzhen (CN); Jinjing FANG, Shenzhen (CN); Yunyang LIU, Shenzhen (CN); Lidan YE, Shenzhen (CN)

(21) Appl. No.: 19/481,172

(22) PCT Filed: Oct. 20, 2023
(86) PCT No.: PCT/CN2023/125706

§ 371 Date: Nov. 3, 2025

(30) Foreign Application Priority Data
May 11, 2023 (CN) 202310526659.X

(51) Int. Cl. G02F 1/1333; G02F 1/1339; G02F 1/136

(52) U.S. Cl. CPC G02F 1/133311; G02F 1/133334; G02F 1/1339; G02F 1/136; G02F 2201/503

(57) ABSTRACT

The present application discloses a display panel and a display device. A driver chip controls a magnetic magnitude or direction of each first magnetic structure and each second magnetic structure individually based on a signal from a pressure sensor. A magnetic force between the first magnetic structure and the second magnetic structure is equal to a force exerted on the first substrate and the second substrate. A direction of the magnetic force between the first magnetic structure and the second magnetic structure is opposite to a direction of the force exerted on the first substrate and the second substrate.

### CROSS-REFERENCE TO RELATED APPLICATIONS

This application claims the benefit and priority of Chinese patent application number CN202310526659X, titled “Display Panel and Display Device”, and filed on May 11, 2023 with China National Intellectual Property Administration, the entire contents of which are hereby incorporated herein by reference.

### TECHNICAL FIELD

This application relates to the field of display, and more particularly relates to a display panel and a display device.

### BACKGROUND

The description provided in this section is intended for the mere purpose of providing background information related to the present application but does not necessarily constitute prior art.

In a current display panel, spacer columns are mainly used to maintain a stable cell thickness of the display panel. In daily life, the display screen is sometimes squeezed by external forces. When the external force is too large, the thickness of the squeezed portion will be reduced. When the liquid crystal inside the display panel expands due to heat, the cell thickness will increase, resulting in uneven cell thickness thus leading to mura. In severe cases, the spacer columns on the color filter substrate side of the panel will squeeze the array substrate on the opposite side so that the spacer columns and the alignment film rub against each other to produce alignment debris. The alignment debris may move to the display area and affect the arrangement of the liquid crystal, resulting in dark-state light leakage and a large number of broken bright spots on a black-state image.

Therefore, how to solve the problem of broken bright spots and maintain the uniformity of cell thickness without arranging spacer columns has become an urgent problem to be solved in the field.

### SUMMARY

This application discloses a display panel and a display device, one purpose of which is to solve the problem of broken bright spots and maintain the uniformity of cell thickness without providing spacer columns.

The present application discloses a display panel, including a first substrate, a second substrate, and a liquid crystal layer. The first substrate and the second substrate are aligned and bonded with each other to form a cell. The liquid crystal layer is arranged between the first substrate and the second substrate. A first magnetic structure is arranged on a side of the first substrate facing towards the liquid crystal layer. A second magnetic structure is arranged on a side of the second substrate facing towards the liquid crystal layer. The positions of the first magnetic structure and the second magnetic structure correspond to each other. Each of the first substrate and the second substrate includes a pressure sensor corresponding to each first magnetic structure and each second magnetic structure. The display panel further includes a driver chip. Each pressure sensor is connected to the driver chip. The driver chip controls a magnetic magnitude or direction of each first magnetic structure and each second magnetic structure separately according to a signal from the pressure sensor. The magnetic force between the first magnetic structure and the second magnetic structure is equal to a force applied to the first substrate and the second substrate. The direction of the magnetic force between the first magnetic structure and the second magnetic structure is opposite to the direction of the force acted on the first substrate and the second substrate.

The present application further discloses a display device, including an optical assembly. The display device further includes the above-mentioned display panel. The display panel is arranged on a side of a light-emitting surface of the optical assembly.

The present application arranges the first magnetic structure and the second magnetic structure in the first substrate and the second substrate respectively, and utilizes the magnetic force between the first magnetic structure and the second magnetic structure to replace the traditional spacer column to support the first substrate and the second substrate. This can effectively avoid the friction between the spacer column and the alignment film after the display panel is subjected to an external force, thus effectively solving the problem of broken bright spots caused by the production of alignment debris. It is particularly important that there are arranged pressure sensors at the first magnetic structure and the second magnetic structure. When there is an external force that acts on the display panel, the pressure sensor senses the pressure from the outside and generates and sends a signal to the driver chip. The driver chip outputs a corresponding current according to the pressure to act on the first magnetic structure and the second magnetic structure. At this time, the magnetism of the first magnetic structure is the same as that of the second magnetic structure, and the repulsive force generated is equal to a combined force of the external force at the pressure point and a gravity of the display panel itself or a component force of the gravity of the display panel in other directions, so as to maintain the stable cell thickness of the pressure point of the display panel. When the liquid crystal panel is locally heated unevenly, the liquid crystal in some area of the cell of the display panel is heated and expanded. At this time, the pressure sensor senses the force created by the expansion of the liquid crystal, and then generates a signal and transmits it to the driver chip. The driver chip adjusts the current direction of the first magnetic structure and the second magnetic structure at the force point according to the received signal, and changes the magnetic direction of the first magnetic structure and the second magnetic structure by adjusting the current direction. The attraction force generated at the position of expansion makes the force at the pressing position reach a force balance, preventing the liquid crystal from expanding outward and ensuring the uniformity of the cell thickness. In this way, the problem of broken bright spots can be solved without setting a spacer column, and the uniformity of the cell thickness of the display panel can be dynamically adjusted.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principle of the present application in conjunction with the text description. Apparently, the drawings in the following description merely represent some embodiments of the present disclosure, and for those having ordinary skill in the art, other drawings may also be obtained based on these drawings without investing creative. In the drawings:

FIG. 1 is a schematic diagram of a first embodiment of a display panel of the present application.

FIG. 2 is a schematic diagram of an electromagnet in the first embodiment of a display panel of the present application.

FIG. 3 is a schematic diagram of a second embodiment of a display panel of the present application.

FIG. 4 is a partial top view of a third embodiment of a display panel of the present application.

FIG. 5 is a partial top view of a fourth embodiment of a display panel of the present application.

FIG. 6 is a partial top view of a fifth embodiment of a display panel of the present application.

FIG. 7 is a schematic diagram of a sixth embodiment of a display panel of the present application.

FIG. 8 is a schematic diagram of an embodiment of a display device of the present application.

### DETAILED DESCRIPTION OF EMBODIMENTS

The present application will be described in detail below with reference to the accompanying drawings and optional embodiments. It should be noted that, should no conflict be present, the various embodiments or technical features described below can be combined arbitrarily to form new embodiments.

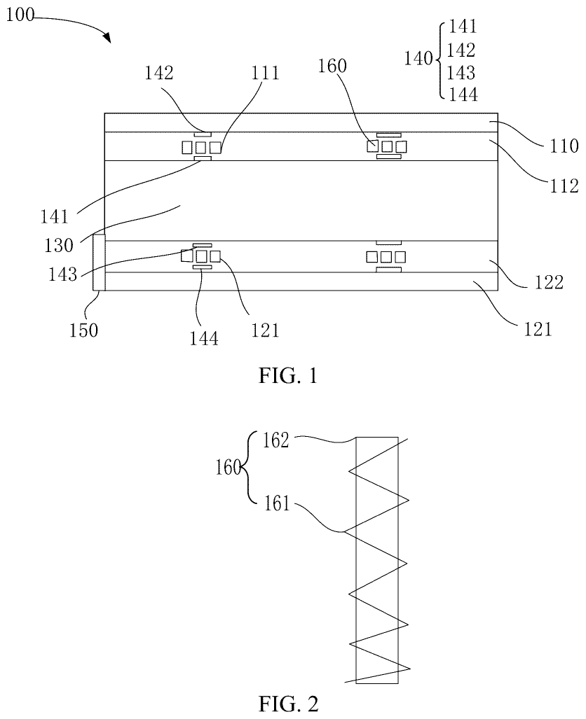

FIG. 1 is a schematic diagram of a first embodiment of a display panel of the present application. As shown in FIG. 1, the present application discloses a display panel 100, including a first substrate 110, a second substrate 120, and a liquid crystal layer 130. The first substrate 110 and the second substrate 120 are aligned and bonded with each other. The liquid crystal layer 130 is arranged between the first substrate 110 and the second substrate 120. The first magnetic structure 111 is arranged on a side of the first substrate 110 facing towards the liquid crystal layer 130. The second magnetic structure 121 is arranged on a side of the second substrate 120 facing towards the liquid crystal layer 130. The positions of the first magnetic structure 111 and the second magnetic structure 121 correspond to each other. The first substrate 110 and the second substrate 120 each include a pressure sensor 140 corresponding to each first magnetic structure 111 and each second magnetic structure 121. The display panel 100 further includes a driver chip 150. Each pressure sensor 140 is connected to the driver chip 150. The driver chip 150 controls a magnetic magnitude or direction of each first magnetic structure 111 and each second magnetic structure 121 individually based on a signal from the respective pressure sensor 140. A magnetic force between the first magnetic structure 111 and the second magnetic structure 121 is equal to a force exerted on the first substrate 110 and the second substrate 120. A direction of the magnetic force between the first magnetic structure 111 and the second magnetic structure 121 is opposite to a direction of the force exerted on the first substrate 110 and the second substrate 120.

The present application arranges the first magnetic structure 111 and the second magnetic structure 121 in the first substrate 110 and the second substrate 120 respectively, and utilizes the magnetic force between the first magnetic structure 111 and the second magnetic structure 121 to replace the traditional spacer column to support the first substrate 110 and the second substrate 120. This can effectively avoid the friction between the spacer column and the alignment film after the display panel 100 is subjected to an external force, thus effectively solving the problem of broken bright spots caused by the production of alignment debris. It is particularly important that there are arranged pressure sensors 140 at the first magnetic structure 111 and the second magnetic structure 121. When there is an external force that acts on the display panel 100, the pressure sensor senses the pressure from the outside and generates and sends a signal to the driver chip 150. The driver chip 150 outputs a corresponding current according to the pressure to act on the first magnetic structure 111 and the second magnetic structure 121. At this time, the magnetism of the first magnetic structure 111 is the same as that of the second magnetic structure 121, and the repulsive force generated is equal to a combined force of the external force at the pressure point and a gravity of the display panel 100 itself or a component force of the gravity of the display panel 100 in other directions, so as to maintain the stable cell thickness of the pressure point of the display panel 100. When the liquid crystal panel is locally heated unevenly, the liquid crystal in some area of the cell of the display panel 100 is heated and expanded. At this time, the pressure sensor 140 senses the force created by the expansion of the liquid crystal, and then generates a signal and transmits it to the driver chip 150. The driver chip 150 adjusts the current direction of the first magnetic structure 111 and the second magnetic structure 121 at the force point according to the received signal, and changes the magnetic direction of the first magnetic structure 111 and the second magnetic structure 121 by adjusting the current direction. The attraction force generated at the position of expansion makes the forces at the pressing position reach a force balance, preventing the liquid crystal from expanding outward and ensuring the uniformity of the cell thickness. In this way, the problem of broken bright spots can be solved without setting a spacer column, and the uniformity of the cell thickness of the display panel 100 can be dynamically adjusted.

Regarding the relationships between the direction and magnitude of the magnetic force and the direction and magnitude of the applied force in this application, it should be noted that when the display panel 100 is placed horizontally, the applied force on the display panel 100 is equal to the combined force of the external force acting on the display panel 100 and the gravity of the display panel 100 itself, and when the display panel 100 is placed at an angle, the applied force on the display panel 100 is the combined force of the external force acting on the display panel 100 and the component force of the gravity of the display panel 100 in the direction perpendicular to the display panel 100.

Take the case where the display panel 100 is placed horizontally as an example. When the display panel 100 is acted upon by an external force, the actual force applied to the display panel 100 is equal to the force applied by the outside plus the gravity of the display panel 100 itself. That is, the force applied by the outside is oriented in the same direction as the gravity of the display panel 100 itself. At this time, the magnetism of the first magnetic structure 111 and that of the second magnetic structure 121 are of the same polarity, thus generating a mutual repulsion force, which is oriented in the opposite direction to the force applied by the outside. The magnitude of the magnetic force between the first magnetic structure 111 and the second magnetic structure 121 is equal to the combined force of the external force and the gravity of the display panel 100 itself, thereby maintaining the uniformity of the cell thickness of the compressed portion of the display panel 100. When the display panel 100 expands due to heat, the expansion force generated is oriented toward the outside of the display panel 100, which is opposite to the gravity of the display panel 100. Thus, the actual force applied to the display panel 100 is the gravity of the display panel 100 minus the expansion force applied to the display panel 100. At this time, the first magnetic structure 111 and the second magnetic structure 121 have different magnetic polarities, thus generating an attractive force oriented in the opposite direction to the expansion force. The magnitude of the magnetic force between the first magnetic structure 111 and the second magnetic structure 121 is equal to the combined force of the expansion force of the display panel 100 and the gravity of the display panel 100 itself, thereby maintaining the uniformity of the cell thickness of the expanding part of the display panel 100.

When the display panel 100 is tilted, the gravity of the display panel 100 generates a component force in the tilted direction. At this time, when the display panel 100 is acted upon by an external force, the actual force applied to the display panel 100 is equal to the force applied by the outside plus the component force of the gravity of the display panel 100 in the tilt direction. In this case, the magnetism of the first magnetic structure 111 and that of the second magnetic structure 121 are of the same polarity, thus generating a mutual repulsion force, the direction of which is opposite to the force applied by the outside and the component force of the gravity of the display panel 100 in the tilt direction. The magnitude of the magnetic force between the first magnetic structure 111 and the second magnetic structure 121 is equal to the resultant force of the magnitude of the external force and the component force of the gravity of the display panel 100 in the tilt direction, thereby maintaining the uniformity of the cell thickness of the compressed part of the display panel 100. When the display panel 100 is heated and expanded, the expansion force generated points toward the outside of the display panel 100, which is opposite to the direction of the component force of the gravity of the display panel 100 in the tilted direction. The actual force applied to the display panel 100 is the component force of the gravity of the display panel 100 in the tilted direction minus the expansion force generated by the display panel 100. At this time, the first magnetic structure 111 and the second magnetic structure 121 have different magnetic polarities, thus generating an attractive force which is oriented in the opposite direction to the direction of the resultant force of the expansion force and the component force of the gravity of the display panel 100 in the tilted direction. The magnitude of the magnetic force between the first magnetic structure 111 and the second magnetic structure 121 is equal to the resultant force of the expansion force of the display panel 100 and the component force of the gravity of the display panel 100 in the tilted direction, so as to maintain the uniformity of the cell thickness of the expanded part of the display panel 100.

In various embodiments of the present application, only the stress condition of the display panel when placed horizontally is used as an example.

In addition, in order to enable the first magnetic structure 111 and the second magnetic structure 121 to create a relatively stable magnetic force to maintain the uniformity of the cell thickness of the display panel 100, the first magnetic structure 111 and the second magnetic structure 121 may further be particularly designed as follows.

FIG. 2 is a schematic diagram of an electromagnet in the first embodiment of the display panel of this application. As shown in FIG. 2 and FIG. 1, the first magnetic structure 111 and the second magnetic structure 121 each include an electromagnet 160. Each electromagnet 160 is electrically connected to the driver chip 150. The electromagnet 160 includes a nanotube coil 161 and a ferromagnetic core 162. The ferromagnetic core 162 is disposed inside nanotube coil 161. The nanotube coil 161 has a diameter ranging from 2 nanometers to 4 nanometers. A height of the nanocoil ranges from 110 nanometers to 130 nanometers.

The first magnetic structure 111 and the second magnetic structure 121 designed in this way can have dozens of coil turns, which have the potential to be used as miniature electromagnetic coils. In addition, by introducing the micro ferromagnetic core 162 into the nanotube coil 161, the inductance and magnetic flux density can be significantly increased, forming a relatively powerful micro electromagnet 160, which is beneficial to providing stable support for the display panel 100 to maintain a uniform cell thickness.

In the present application, the first magnetic structure 111 and the second magnetic structure 121 do not simply use magnetic support as a substitute for the traditional spacer column support. Instead, when a local position or some portion of the display panel 100 is subjected to a force that points from the outside toward the inside of the display panel 100, or an expansion force that points from the inside of the display panel 100 toward the outside of the display panel 100, the first magnetic structure 111 and the second magnetic structure 121 are used to dynamically adjust the magnitude and direction of the magnetic force at the local forced position of the display panel 100, so as to achieve dynamic adjustment of the uniformity of the cell thickness of the display panel 100. Therefore, the specific designs adopted for the first magnetic structure 111 and the second magnetic structure 121 of the present application may be particularly as follows.

The first magnetic structure 111 and the second magnetic structure 121 each include at least three spaced-apart electromagnets 160. The electromagnets 160 of the first magnetic structure 111 are arranged in one-to-one correspondence with the electromagnets 160 of the second magnetic structure 121. When the direction of the force applied to the first substrate 110 and the second substrate 120 points toward the inside of the display panel 100, the three electromagnets 160 of the first magnetic structure 111 and the three electromagnets 160 of the second magnetic structure 121 have the same magnetic polarity. When the direction of the force applied to the first substrate 110 and the second substrate 120 points toward the outside of the display panel 100, at least one electromagnet 160 in the first magnetic structure 111 has an opposite magnetic polarity to at least one electromagnet 160 in the second magnetic structure 121.

For example, when the display panel 100 is heated unevenly, the liquid crystal in some area of the cell of the display panel 100 expands due to the heat. The stress generated in the expanded area acts on the film layers on the substrate, and the liquid crystal in this area tends to diffuse to other areas due to thermal expansion, where the direction of the expansion force generated by the liquid crystal in the cell is consistent with the direction pointing towards the outside of the display panel 100. At this time, the pressure sensor 140 adjacent to the liquid crystal side of the cell senses the force generated by the expansion of the liquid crystal, and accordingly generates a signal and transmits it to the driver chip 150. The driver chip 150 adjusts a current direction of each electromagnet 160 in the first magnetic structure 111 and the second magnetic structure 121 at the stressed point of the display panel 100 according to the signal. By adjusting the current direction, the magnetic pole of one of the electromagnets 160 in the first magnetic structure 111 changes to the S pole, and the magnetic pole of an electromagnet 160 in the second magnetic structure 121 corresponding to the first magnetic structure 111 becomes the N pole, so that the corresponding electromagnets 160 in the first magnetic structure 111 and the second magnetic structure 121 generate an attractive force therebetween, whereby the force acting on the expansion part and the generated attractive force are balanced, preventing the liquid crystal from expanding outward thus ensuring the uniformity of the cell thickness. Furthermore, the cell thickness in this area is maintained by the repulsion generated by the remaining two corresponding electromagnets 160 in each of the first magnetic structure 111 and the second magnetic structure 121.

That is, in this application, through the three electromagnets 160 in each of the first magnetic structure 111 and the second magnetic structure 121, the repulsive force between the middle electromagnets 160 mainly serves a supporting function, while the left and right electromagnets 160 serve the function of adjusting the cell thickness when the substrate is subjected to an external force or thermal expansion and contraction. The control of the cell thickness is thus achieved through the respective roles of the three electromagnets 160.

Further, the first substrate 110 includes a first planarization layer 112 on the side facing towards the liquid crystal layer 130. The first magnetic structure 111 is disposed in the first planarization layer 112. The second substrate 120 includes a second planarization layer 122 on the side facing towards the liquid crystal layer 130. The second magnetic structure 121 is disposed in the second planarization layer 122. Multiple pressure sensors 140 are disposed in each of the first planarization layer 112 and the second planarization layer 122. The pressure sensors 140 include a first sensor 141, a second sensor 142, a third sensor 143, and a fourth sensor 144. The first sensor 141 is disposed on the side of the first magnetic structure 111 facing towards the liquid crystal layer 130. The second sensor 142 is disposed on the side of the first magnetic structure 111 facing away from the liquid crystal layer 130. The first magnetic structure 111 is disposed between the first sensor 141 and the second sensor 142. The third sensor 143 is arranged on the side of the second magnetic structure 121 facing towards the liquid crystal layer 130. The fourth sensor 144 is arranged on the side of the second magnetic structure 121 facing away from the liquid crystal layer 130. The second magnetic structure 121 is disposed between the third sensor 143 and the fourth sensor 144.

In the present application, pressure sensors 140 are disposed on both the inner and outer sides of the first magnetic structure 111 and the second magnetic structure 121 relative to the liquid crystal layer 130, so that the pressure sensors 140 can not only sensitively sense the forces from the outside of the display panel 100, but also sense the expansion forces from the inside of the display panel 100. When the pressure sensors 140 sense the changes in external pressure and internal stress, each pressure sensor 140 may transmit a signal to the driver chip 150 according to different stress magnitudes and stress directions. The driver chip 150 is used to adjust the current magnitudes and current directions so that the first magnetic structure 111 and the second magnetic structure 121 generate different magnetic force magnitudes and magnetic pole directions, so that the cell thickness of the display panel 100 is uniform and tends to be consistent.

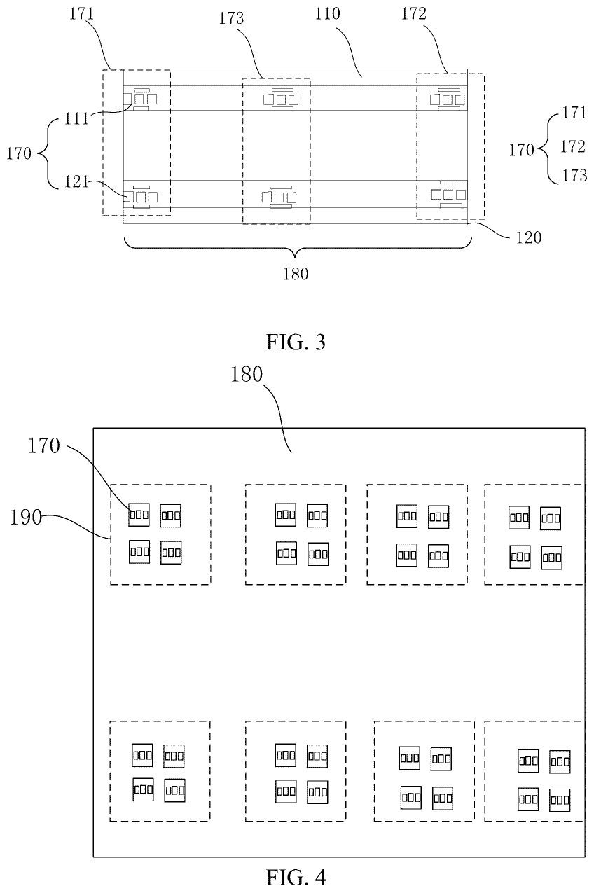

FIG. 3 is a schematic diagram of a second embodiment of a display panel of the present application. As shown in FIG. 3, the embodiment shown in FIG. 3 is an improvement based on FIG. 1. Each first magnetic structure 111 and the corresponding second magnetic structure 121 form a magnetic group 170. The magnetic groups 170 include a first magnetic group 171, a second magnetic group 172, and a third magnetic group 173. The first substrate 110 and the second substrate 120 are each divided to have a display area 180. The first magnetic group 171 and the second magnetic group 172 are each disposed at an edge of the display area 180. The third magnetic group 173 is arranged in a middle of the display area 180.

The key parts of the display panel 100 that need to be supported are both sides of the display panel 100 and the middle of the display panel 100. When both sides and the middle of the display panel 100 are effectively supported, the collapse of the display panel 100 can be prevented, and the thickness stability of the display panel 100 can be effectively maintained. Therefore, in this embodiment, the magnetic group 170 composed of the first magnetic structure 111 and the second magnetic structure 121 is disposed at the two edges in the display area 180 and in the middle of the display area 180. The magnetic force generated by the first magnetic structure 111 and the second magnetic structure 121 is used to make the first magnetic group 171, the second magnetic group 172, and the third magnetic group 173 each perform magnetic support from the three key positions in the display area 180, so as to maintain the uniformity of the cell thickness of the display panel 100. Furthermore, the number of the first magnetic structures 111 and the second magnetic structures 121 can be effectively reduced, which is conducive to cost saving.

FIG. 4 is a partial top view of a third embodiment of a display panel of the present application. As shown in FIG. 4, the embodiment shown in FIG. 4 is an improvement based on FIG. 1. The display area 180 is further divided into a plurality of magnetic sections 190 arranged in an array. Each magnetic section 190 includes at least two magnetic groups 170. The at least two magnetic groups 170 are located in a center of the magnetic section 190.

Different from the previous embodiment, in this embodiment the display area 180 is divided into a plurality of magnetic sections 190 arranged in an array to correspond to different forced positions of the display panel 100. At least two magnetic groups 170 are disposed in each magnetic section 190, so that the two magnetic groups 170 may cooperate to adjust the magnitude and direction of the magnetic force in the entire magnetic section 190 according to the magnitude and direction of the force acted in each magnetic section 190, forming a dynamic force balance in the local area and maintaining the stability of the local cell thickness of the display panel 100.

For example, when a certain position on the display panel 100 is acted upon by an external force, the force may be applied to a magnetic section 190. The pressure sensors 140 located in the magnetic section 190 detect the magnitude of the force acted on the display panel 100 and transmit a detection signal to the driver chip 150. The driver chip 150 controls the magnitude and direction of the currents of the two magnetic groups 170 in the magnetic section 190 according to the signal. When the position where the external force mainly acts is closer to one of the magnetic groups 170, the closer magnetic group 170 obtains a larger current intensity and generates a stronger magnetic repulsion force. The farther magnetic group 170 obtains a smaller current intensity and generates a magnetic repulsion force to compensate for the lack of magnetic force generated by the magnetic group 170 closer to the force position. Alternatively, when the force is too large at a certain moment, and the magnetic force of the magnetic group 170 closer to the forced position exceeds the force in a short period of time, the direction of the magnetism of the magnetic group 170 farther from the forced position is changed, so that it is converted from repulsive force to attractive force, and partially offsets the magnetic force generated by the magnetic group 170 closer to the forced position, so as to maintain the overall force balance in the entire magnetic section 190, and eliminate the problem of local force imbalance caused by the randomness of the position of the external force acting on the display panel 100.

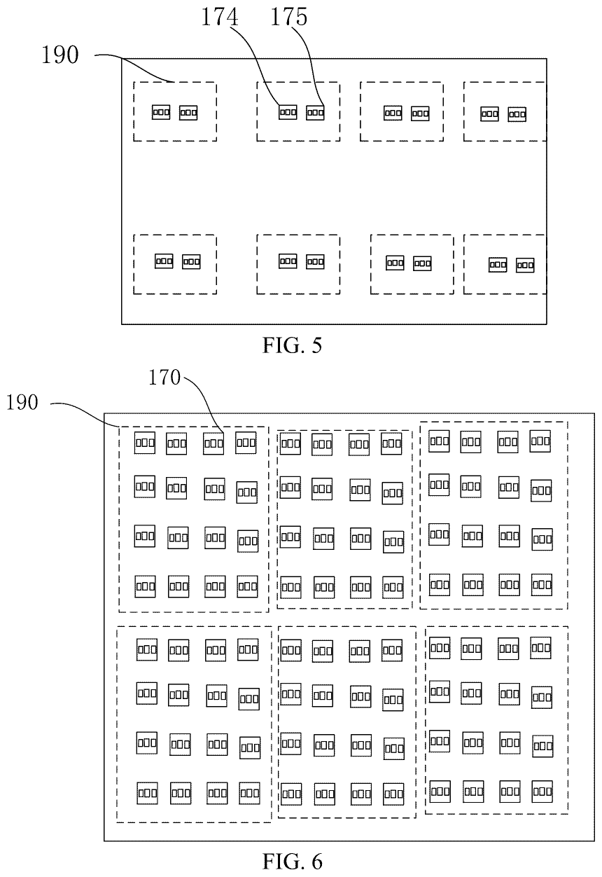

FIG. 5 is a partial top view of a fourth embodiment of a display panel of the present application. As shown in FIG. 5, the embodiment shown in FIG. 5 is an improvement based on FIG. 4. Each magnetic section 190 includes a fourth magnetic group 174 and a fifth magnetic group 175. The magnetic directions of the fourth magnetic group 174 and the fifth magnetic group 175 are opposite, and the sum of the magnetic forces of the fourth magnetic group 174 and the fifth magnetic group 175 is equal to the force acting on the magnetic section 190.

The difference between this embodiment and the previous embodiment is that in this embodiment a fourth magnetic group 174 and a fifth magnetic group 175 with opposite magnetic directions are arranged in each magnetic section 190. That is, in the same magnetic section 190, the fourth magnetic group 174 exhibits a repulsive force of the same polarity, and the fifth magnetic group 175 exhibits an attractive force of opposite polarities. Through the cooperation of the repulsive force of the fourth magnetic group 174 and the attractive force of the fifth magnetic group 175, the forces acting on the display panel 100 are balanced to achieve the local force balance of the display panel 100 thus realizing the dynamic stability adjustment of the cell thickness of the display panel 100.

For example, when the corresponding magnetic section 190 of the display panel 100 is subjected to a pressure from the outside of the display panel 100, the repulsive force of the fourth magnetic group 174 in the magnetic section 190 is relatively large, and the attractive force of the fifth magnetic group 175 is significantly small or close to zero. The fourth magnetic group 174 and the fifth magnetic group 175 in the entire magnetic section 190 as a whole generate a repulsive force opposite to the force acting on the display panel 100 to maintain the cell thickness stability of the display panel 100. When the corresponding magnetic section 190 of the display panel 100 is subjected to an expansion force from the inside of the display panel 100, the repulsive force of the fourth magnetic group 174 in the magnetic section 190 is relatively small, and the attractive force of the fifth magnetic group 175 is relatively large. That is, the attractive force of the fifth magnetic group 175 is used to offset the expansion force inside the display panel 100. The repulsive force of the fourth magnetic group 174 is used to maintain the overall force balance of the display panel 100, thereby effectively supporting the display panel 100 while maintaining the uniformity of the local cell thickness of the display panel 100.

FIG. 6 is a partial top view of a fifth embodiment of a display panel of the present application. As shown in FIG. 6, the embodiment shown in FIG. 6 is an improvement based on FIG. 4. A plurality of magnetic groups 170 are arranged in each magnetic section 190, and the plurality of magnetic groups 170 are arranged in an array in the magnetic section 190.

Since there are relatively more magnetic groups 170 in each magnetic section 190, the magnetic forces in each magnetic section 190 can be adjusted more finely by coordinating the magnitudes and directions of the magnetic forces of the multiple magnetic groups 170, which is more conducive to maintaining the uniformity of the local cell thickness of the display panel 100. Furthermore, the multiple array-arranged magnetic groups 170 may generate a stronger magnetic force to cope with a relatively large force applied to the display panel 100 at a certain moment, effectively preventing the risk of collapse of the display panel 100 under a relatively large force.

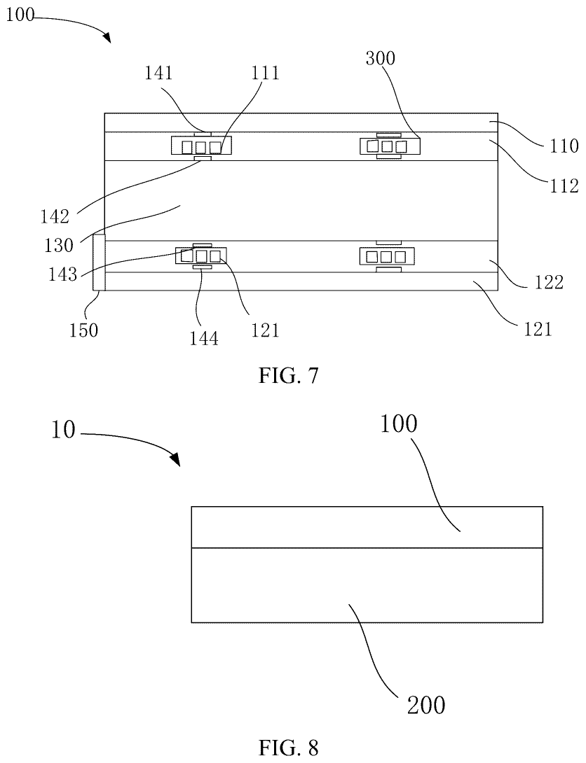

FIG. 7 is a schematic diagram of a sixth embodiment of a display panel of the present application. As shown in FIG. 7, the embodiment shown in FIG. 7 is an improvement based on FIG. 1. The display panel 100 further includes a plurality of electromagnetic shielding structures 300. Each first magnetic structure 111 and each second magnetic structure 121 are disposed in the electromagnetic shielding structure 300.

The present embodiment is different from the embodiment shown in FIG. 1 in that an electromagnetic shielding structure 300 is disposed on the outside of each first magnetic structure 111 and each second magnetic structure 121 in the present embodiment. The electromagnetic shielding structure 300 can be used to minimize the influence of the magnetic field of the electromagnet 160 on other components or devices in the display panel 100 to ensure the normal display of the display panel 100.

FIG. 8 is a schematic diagram of an embodiment of a display device of the present application. As shown in FIG. 8, the present application further discloses a display device 10, including an optical assembly 200. The display device 10 further includes the above-mentioned display panel 100. The display panel 100 is arranged on a side of a light-emitting surface of the optical assembly 200. The display panel 100 itself does not emit light, and the optical assembly 200 provides the display panel 100 with a light source for normal display to ensure the display quality of the display device 10.

In order to solve the problem that the display panel 100 in the traditional display device 10 is supported by the spacer column, and after the display panel 100 is subjected to a force, the spacer column and the alignment film rub against each other to produce alignment debris, which affects the quality of the display device 10, the present application improves the display panel 100 in the display device 10, and the specific improvements are as follows.

The present application arranges the first magnetic structure 111 and the second magnetic structure 121 in the first substrate 110 and the second substrate 120 respectively, and utilizes the magnetic force between the first magnetic structure 111 and the second magnetic structure 121 to replace the traditional spacer column to support the first substrate 110 and the second substrate 120. This can effectively avoid the friction between the spacer column and the alignment film after the display panel 100 is subjected to an external force, thus effectively solving the problem of broken bright spots caused by the production of alignment debris, thereby further improving the quality of the display device 10.

It should be noted that the inventive concept of the present application can be formed into many embodiments, but the length of the application document is limited and so these embodiments cannot be enumerated one by one. The technical features can be arbitrarily combined to form a new embodiment, and the original technical effect may be enhanced after the various embodiments or technical features are combined.

The foregoing description is merely a further detailed description of the present application made with reference to some specific illustrative embodiments, and the specific implementations of the present application will not be construed to be limited to these illustrative embodiments. For those having ordinary skill in the technical field to which this application pertains, numerous simple deductions or substitutions may be made without departing from the concept of this application, which shall all be regarded as falling within the scope of protection of this application.

1. A display panel, comprising a first substrate, a second substrate, and a liquid crystal layer; wherein the first substrate and the second substrate are aligned and bonded with each other to form a cell; wherein the liquid crystal layer is arranged between the first substrate and the second substrate;
wherein there is disposed at least one first magnetic structure on a side of the first substrate facing towards the liquid crystal layer, wherein there is disposed at least one second magnetic structure on a side of the second substrate facing towards the liquid crystal layer, wherein each of the at least one first magnetic structure is disposed at a position corresponding to a position of the respective second magnetic structure;
wherein the first substrate comprises a respective pressure sensor disposed corresponding to each of the at least one first magnetic structure, and wherein the second substrate comprises a respective pressure sensor disposed corresponding to each of the at least one second magnetic structure;
wherein the display panel further comprises a driver chip, wherein each of the pressure sensors is connected to the driver chip, wherein the driver chip is configured to control a magnetic magnitude or direction of each of the at least one first magnetic structure and a magnetic magnitude or direction of each of the at least one second magnetic structure individually depending on a signal from each of the pressure sensors; wherein a magnetic force between the at least one first magnetic structure and the at least one second magnetic structure is equal in magnitude to a force acting on the first substrate and the second substrate; wherein a direction of the magnetic force between the first magnetic structure and the second magnetic structure is opposite to a direction of the force acting on the first substrate and the second substrate.

2. The display panel as recited in claim 1, wherein each of the at least one first magnetic structure and the at least one second magnetic structure comprises an electromagnet, which is electrically connected to the driver chip and which comprises a nanotube coil and a ferromagnetic core disposed in the nanotube coil.

3. The display panel as claimed in claim 2, wherein the nanotube coil has a diameter that dies in the range of 2 nanometers to 4 nanometers; wherein the nanotube coil has a height that lies in the range of 110 nanometers to 130 nanometers.

4. The display panel as recited in claim 2, wherein each of the at least one first magnetic structure and the at least one second magnetic structure comprises at least three electromagnets that are spaced apart from each other, wherein the at least three electromagnets of the first magnetic structure are disposed in one-to-one correspondence in position with the at least three electromagnets of the second magnetic structure.

5. The display panel as recited in claim 4, wherein in response to the force acting on the first substrate and the second substrate and having a direction pointing to an inner side of the display panel, the driver chip is configured to control a magnetic polarity of the at least three electromagnets of the first magnetic structure to be identical with that of the at least three electromagnets of the second magnetic structure;
wherein in response to the force acting on the first substrate and the second substrate and having a direction pointing to an outer side of the display panel, the driver chip is configured to control a magnetic polarity of at least one electromagnet in the first magnetic structure to become opposite to a magnetic polarity of at least one electromagnet in the second magnetic structure.

6. The display panel as recited in claim 2, wherein there is disposed a first planarization layer on a side of the first substrate facing towards the liquid crystal layer, wherein the at least one first magnetic structure is disposed in the first planarization layer, wherein there is disposed a second planarization layer on a side of the second substrate facing towards the liquid crystal layer, wherein the at least one second magnetic structure is disposed in the second planarization layer.

7. The display panel as recited in claim 6, wherein there is disposed a plurality of the pressure sensors in the first planarization layer and the second planarization layer respectively; wherein the plurality of pressure sensors comprise a first sensor, a second sensor, a third sensor, and a fourth sensor;
wherein the first sensor is arranged on a side of each first magnetic structure facing towards the liquid crystal layer, wherein the second sensor is arranged on a side of the first magnetic structure facing away from the liquid crystal layer, wherein the first magnetic structure is disposed between the first sensor and the second sensor; wherein the third sensor is arranged on a side of each second magnetic structure facing towards the liquid crystal layer, wherein the fourth sensor is arranged on a side of the second magnetic structure facing away from the liquid crystal layer, wherein the second magnetic structure is disposed between the third sensor and the fourth sensor.

8. The display panel as recited in claim 1, wherein each of the at least one first magnetic structure and the respective second magnetic structure form a magnetic group, resulting in a plurality of magnetic groups; wherein the plurality of magnetic groups comprise a first magnetic group, a second magnetic group, and a third magnetic group; wherein the first substrate and the second substrate each comprise a display area, wherein the first magnetic group and the second magnetic group are each arranged at a respective edge of the display area, and wherein the third magnetic group is arranged in a middle portion of the display area.

9. The display panel as claimed in claim 8, wherein the display area is further divided into a plurality of magnetic sections that are arranged in an array, wherein each of the plurality of magnetic sections comprises at least two magnetic groups disposed therein, wherein the at least two magnetic groups are disposed in a central portion of the magnetic section.

10. The display panel as recited in claim 9, wherein the first magnetic group and the second magnetic group are configured to provide magnetic support at two edges of the display area, and wherein the third magnetic group is configured to provide magnetic support at the middle portion of the display area.

11. The display panel as claimed in claim 9, wherein the pressure sensor disposed in each of the plurality of magnetic sections is operative to detect a magnitude of the force acting on the display panel and transmit a respective detection signal to the driver chip, and wherein the driver chip is configured to control a magnitude and direction of a current of each of the at least two magnetic groups in the magnetic section based on the detection signal.

12. The display panel as claimed in claim 9, wherein each of the plurality of magnetic sections comprises a fourth magnetic group and a fifth magnetic group, wherein a direction of a magnetic force of the fourth magnetic group is opposite to a direction of a magnetic force of the fifth magnetic group.

13. The display panel as recited in claim 12, wherein a sum of magnetic forces of the fourth magnetic group and the fifth magnetic group is equal to a force acting on the respective magnetic section.

14. The display panel as recited in claim 13, wherein the fourth magnetic group is operative to generate a repulsive force and the fifth magnetic group is operative to generate an attractive force.

15. The display panel as recited in claim 8, wherein each of the plurality of magnetic sections comprise a plurality of magnetic groups arranged therein, wherein the plurality of the magnetic groups are arranged in an array in the respective magnetic section.

16. The display panel as recited in claim 1, further comprising a plurality of electromagnetic shielding structures, wherein each of the at least one first magnetic structure is disposed in the respective electromagnetic shielding structure, and wherein each of the at least one second magnetic structure is disposed in the respective electromagnetic shielding structure.

17. A display device, comprising an optical assembly and a display panel arranged on a side of a light-emitting surface of the optical assembly; wherein the display panel comprises a first substrate, a second substrate, and a liquid crystal layer; wherein the first substrate and the second substrate are aligned and bonded with each other to form a cell; wherein the liquid crystal layer is arranged between the first substrate and the second substrate;
wherein there is disposed at least one first magnetic structure on a side of the first substrate facing towards the liquid crystal layer, wherein there is disposed at least one second magnetic structure on a side of the second substrate facing the liquid crystal layer, wherein each of the at least one first magnetic structure is disposed at a position corresponding to a position of the respective second magnetic structure;
wherein the first substrate comprises a respective pressure sensor disposed corresponding to each of the at least one first magnetic structure, and wherein the second substrate comprises a respective pressure sensor disposed corresponding to each of the at least one second magnetic structure;
wherein the display panel further comprises a driver chip, wherein each of the pressure sensors is connected to the driver chip, wherein the driver chip is configured to control a magnetic magnitude or direction of each of the at least one first magnetic structure and a magnetic magnitude or direction of each of the at least one second magnetic structure individually depending on a signal from each of the pressure sensors; wherein a magnetic force between the at least one first magnetic structure and the at least one second magnetic structure is equal in magnitude to a force acting on the first substrate and the second substrate; wherein a direction of the magnetic force between the first magnetic structure and the second magnetic structure is opposite to a direction of the force acting on the first substrate and the second substrate.
